(19) United States
(12) Patent Application Publication
(10) Pub. No.: US 2016/0203229 A1
(43) Pub. Date: Jul. 14, 2016

(54) SEARCH SERVICE METHOD AND SYSTEM USING USER PARTICIPATION INFORMATION

(71) Applicant: NAVER Corporation, Seongnam-si (KR)

(72) Inventors: Chun Sik GANG, Seongnam-si (KR); Yu Eun PARK, Seongnam-si (KR); Woongsub KIM, Seongnam-si (KR); Tae Ho LEE, Seongnam-si (KR)

(21) Appl. No.: 14/995,323

(22) Filed: Jan. 14, 2016

(30) Foreign Application Priority Data
Jan. 14, 2015 (KR) 10-2015-0006896

(51) Int. Cl. G06F 17/30; H04L 12/58

(52) U.S. Cl. CPC G06F 17/30867; H04L 51/32; G06F 17/30598

(57) ABSTRACT

Search service methods and/or search service systems using a user participation information may be provided. The search service method may include generating a participation topic based on a topic input through a search site, receiving, through the search site, information associated with the participation topic from a user, and storing and managing the received information in association with the participation topic, providing the information stored in association with the participation topic as user participation information through the search site, in response to an input of a keyword, which is associated with the participation topic and input through the search site, and expanding the user participation information based on an input of additional information, in association with the provided information through the search site.

### CROSS-REFERENCE TO RELATED APPLICATION(S)

This application claims priority under 35 U.S.C. §119 to Korean Patent Application No. 10-2015-0006896 filed Jan. 14, 2015, in the [Korean Intellectual Property Office (KIPO)], the entire contents of which are incorporated herein by reference.

### BACKGROUND

1. Field

One or more example embodiments relate to search service methods and/or systems for providing a service that enables a user to participate in an information search result by enabling the user to generate a topic of interest by himself or herself, and by expanding information about the topic in cooperation with other search users.

2. Description of Related Art

This section provides background information related to the present disclosure which is not necessarily prior art.

A search engine refers to software that helps a user easily retrieve desired information from mass materials spread over the Internet. A search method includes, for example, a keyword search method in which the user directly inputs a keyword, that is, a search word, and a category search method of narrowing down a search range in such a manner that the user selects a desired category from among a plurality of categories presented by the search engine.

For example, in response to a keyword that is input through a search site by a user, who is connected to the search site over a wired network or a wireless network, a server providing the search site may retrieve information corresponding to the input keyword and may provide the user with the retrieved information as a search result through the search site.

As described above, search services according to the related art provide users with information that satisfies a condition among information dispersed over the Internet.

### SUMMARY

This section provides a general summary of the disclosure, and is not a comprehensive disclosure of its full scope or all of its features.

One or more example embodiments provide search service methods and/or systems that may provide contents created through participation of users as a user participation search result and enable users to participate in the provided user participation search result.

One or more example embodiments provide search service methods and/or systems that may configure a new information distribution platform.

According to an example embodiment, a search service method using a user participation in an information search result may include generating a participation topic based on a topic input through a search site, receiving, through the search site, information associated with the participation topic from a user, and storing and managing the received information in association with the participation topic, providing the information stored in association with the participation topic as user participation information through the search site, in response to an input of a keyword, which is associated with the participation topic and input through the search site, and expanding the user participation information based on an input of additional information in association with the provided information through the search site.

In some example embodiments, the generating a participation topic may include verifying whether or not a previously generated participation topic with regard to the topic input from the user is present, and generating a new participation topic based on the input topic when the previously generated participation topic is absent.

In some example embodiments, the providing the information may include providing a user with information stored in association with the previously generated participation topic, when the previously generated participation topic is present.

In some example embodiments, the user participation information may include at least one of a video, a photo, and a user opinion, and the search service method further comprises sharing the user participation information between users having input keywords associated with the participation topic through the additional information.

In some example embodiments, the search service method may further include generating a participation space for users using at least a portion of the search site, and providing, in the generated participation space, a user interface capable of inputting the additional information with regard to the user participation information and the participation topic.

In some example embodiments, the generating a participation topic may include issuing an official account for a company or an organization in response to a request from the company or the organization, and generating a participation topic for the official account.

In some example embodiments, the generating a participation topic may include generating the participation topic for an event or a festival associated with the user in response to a request from the user.

In some example embodiments, the search service method may further include assigning evaluation points for each item of information included in the user participation information, based on at least one of a user participation level, a presence of self-production of information, and a presence of a link.

In some example embodiments, the search service method may further include assigning, based on the evaluation points, a master position for the participation topic to a user that is selected from among users having provided information included in the user participation information.

In some example embodiments, the providing the information may include classifying individual information included in the user participation information based on a topic or a content type, and displaying the classified information for each classification item through the search site.

In some example embodiments, the search service method may further include recommending, to the user, generation of the participation topic for a preset keyword or input of the additional information.

In some example embodiments, the preset keyword may include at least one of a keyword that is extracted based on at least one of a number of individual items of information included in the user participation information, a time at which an incident associated with the participation topic has occurred, an expanded keyword for the participation topic, and a keyword that is extracted in association with a location of at least one user.

In some example embodiments, a user having initially input the participation topic that is generated based on the topic input through the search site may become an owner for the participation topic or the owner may be replaced based on a user reaction to the participation topic.

According to an example embodiment, a search service system for providing a search service using a user participation in an information search result, may include one or more processors configured to execute computer-readable instructions to generate a participation topic based on a topic input through a search site, receive, through the search site, information associated with the participation topic from a user, and store and manage the received information in association with the participation topic, provide the information stored in association with the participation topic as user participation information through the search site, in response to an input of a keyword, which is associated with the participation topic and input through the search site, and expand the user participation information based on an input of additional information in association with the provided information through the search site.

In some example embodiments, the processor may be further configured to verify whether or not a previously generated participation topic with regard to the topic input from the user is present, and generate a new participation topic when the previously generated participation topic is absent.

In some example embodiments, the user participation information may include at least one of a video, a photo, and a user opinion, and the processor may be further configured to share the user participation information between users having input keywords associated with the participation topic through the additional information

In some example embodiments, the processor may be further configured to generate a participation space for users using at least a portion of the search site, and provide, in the generated participation space, a user interface capable of inputting the additional information with regard to the user participation information and the participation topic.

In some example embodiments, the processor may be further configured to issue an official account for a company or an organization in response to a request from the company or the organization, and generate a participation topic for the official account.

In some example embodiments, the processor may be further configured to generate the participation topic for an event or a festival associated with the user in response to a request from the user.

In some example embodiments, the processor may be further configured to assign evaluation points for each item of information included in the user participation information, based on at least one of a user participation level, a presence of self-production of information, and a presence of a link.

In some example embodiments, the processor may be further configured to recommend generation of the participation topic for a preset keyword or input of the additional information to the user. The preset keyword may include at least one of a keyword that is extracted based on at least one of a number of individual items of information included in the user participation information, a time at which an incident associated with the participation topic has occurred, an expanded keyword for the participation topic, and a keyword that is extracted in association with a location of at least one user.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail from the following brief description in conjunction with the accompanying drawings, wherein like reference numerals refer to like parts throughout the various drawings unless otherwise specified, and wherein:

FIG. 1 is a flowchart illustrating a search service method using a user participation in an information search result according to one or more example embodiments.

FIG. 2 illustrates an example of an entire process in which a user generates a participation topic according to one or more example embodiments.

FIG. 3 illustrates an example of a process in which a user generates a participation topic and generates a communication space according to one or more example embodiments.

FIGS. 4A and 4B illustrate examples of an event area using a method for inducing user participation with regard to a participation topic according to one or more example embodiments.

FIG. 5 illustrates examples of a method of using a mutual communication space using official accounts of users according to one or more example embodiments.

FIG. 6 illustrates an example of a method of sharing information between users having a common interest according to one or more example embodiments.

FIG. 7 illustrates an example of a participation search result and a participation derived search result according to one or more example embodiments.

FIG. 8 illustrates an example of evaluating users based on a user participation level according to one or more example embodiments.

FIG. 9 illustrates an example of a page of information about a participation topic according to one or more example embodiments.

FIG. 10 illustrates an example of a participation comment according to one or more example embodiments.

FIG. 11 is a block diagram illustrating a configuration of a search service system using a user participation in an information search result according to one or more example embodiments.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to one or more example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, and/or block diagrams) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code may include, for example, machine code produced by a compiler and/or higher level program code that is executable using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out the program code by performing arithmetical, logical, and input/output operations. Once the program code is loaded into the computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, which is capable of providing instructions or data to or being interpreted by a hardware device. The software also may be distributed over network coupled computer systems so that the software is stored and executed in a distributed fashion. In particular, for example, software and data may be stored by one or more computer readable recording mediums, including tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, one or more example embodiments will be described with reference to the accompanying drawings.

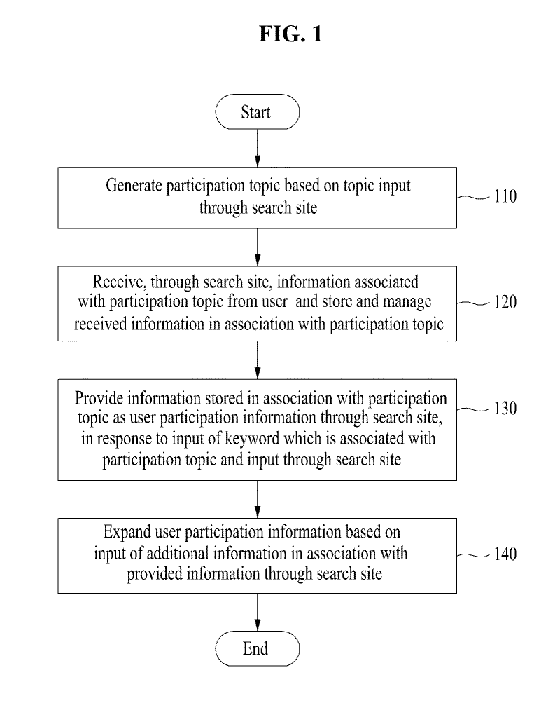

FIG. 1 is a flowchart illustrating a search service method using a user participation in an information search result according to one or more example embodiments. The search service method and operations included therein according to the example embodiments may be performed by a search service system or constituent elements included in the search service system. The search service system will be further described below.

In operation 110, the search service system may generate a participation topic based on a topic input through a search site. For example, the search service system may provide the search site to a terminal of a first user connected to the search service system via a wired network or a wireless network. In response to a keyword input (e.g., topic input) from the first user through the search site, the search service system may request the first user to generate a participation topic with regard to the input keyword. If the first user responds to the request, the search service system may generate the participation topic based on the keyword input from the first user.

That is, search users may generate a participation topic about a topic input in which users are interested.

In operation 110, the search service system may verify whether or not a previously generated participation topic with regard to the topic input from the user is present, and may generate a new participation topic based on the topic input when the previously generated participation topic is absent. An example in which the previously generated participation topic is present will be further described blow.

In operation 120, the search service system may receive, through the search site, information associated with the participation topic from a user, and may store and manage the received information in association with the participation topic. For example, a user having generated a participation topic may input information associated with the participation topic through the search site at the same time. Here, the search service system may store and manage the input information in association with the participation topic.

In operation 130, the search service system may provide the information stored in association with the participation topic as user participation information through the search site, in response to an input of a keyword, which is associated with the participation topic and input through the search site. For example, when a user A inputs a keyword “total eclipse of the moon” and a participation topic “total eclipse of the moon” is present, user participation information stored in association with the participation topic “total eclipse of the moon” may be provided to the user A.

In operation 140, the search service system may expand the user participation information based on an input of additional information in association with the provided information through the search site. According to an example embodiment, a user interface for inputting information associated with the participation topic may be provided to the user A through the search site. When the user A inputs additional information about the participation topic “total eclipse of the moon”, the search service system may expand the user participation information about the participation topic “total eclipse of the moon” based on the additional information.

When the previously generated participation topic is present with respect to the topic input from the user, the search service system may provide the user with user participation information stored in association with the previously generated participation topic. Here, the user may input additional information with regard to the previously generated participation topic.

As described above, the user participation information may include information input by the user in association with the participation topic and include various types of information, for example, a video, a photo, and/or a user opinion. Here, the user participation information may be shared between users having input keywords associated with the participation topic through the additional information.

The search service system may generate a participation space for users using at least a portion of the search site, and may provide, in the generated participation space, a user interface capable of inputting additional information with regard to the user participation information and the participation topic. The user interface may be used for the users to input the additional information (e.g., to perform operation 140).

The participation topic may be generated by general search users. The participation topic may be generated for an official account of a company or an organization in response to a request from the company or the organization. For example, company name “AAA” of company “AAA” may be generated as a participation topic. Generation of a participation topic in response to a request from a company or an organization may be utilized as a business model in which the company or the organization is charged with cost for generation of the participation topic or cost for effect of the participation topic.

Further, the participation topic may be generated for an event or a festival associated with a specific user in response to a request from the specific user. Generation of the participation topic in response to the request from the specific user may also be utilized as a business model in which the specific user is charged with cost for generation of the participation topic or cost for effect of the participation topic.

According to one or more example embodiments, although not illustrated, the search service method may further include assigning evaluation points for each item of information included in the user participation information, based on at least one of a user participation level, a presence of self-production of information, and a presence of a link, in addition to operations 110 through 140 of FIG. 1. The evaluation points may be used to assign a master position for the participation topic to a user that is selected from among users having provided information included in the user participation information. For example, a master position for a participation topic “total eclipse of the moon” may be assigned to a user having input information corresponding to highest evaluation points among a plurality of users having input information with regard to the participation topic “total eclipse of the moon”. The master position may be simply a position for honor and may also be a position for which preset compensation is guaranteed. For example, users may be induced to improve the quality of user participation information by providing the preset compensation to the user with the master position.

Also, the user participation information may be managed as separate information for each item of information input from the users, instead of being managed as a single item of information with regard to the participation topic. Further, the user participation information may be classified based on a topic or a content type and may be displayed for each classification item through the search site.

According to one or more example embodiments, although not illustrated, the search service method may further include recommending, to the user, generation of the participation topic for a preset keyword or input of the additional information in addition to operations 110 through 140 of FIG. 1. For example, the preset keyword may include at least one of a keyword that is extracted based on at least one of the number of individual items of information included in the user participation information, a time at which an incident associated with the participation topic has occurred, an expanded keyword for the participation topic, and a keyword that is extracted in association with a location of at least one user.

For example, when the number of individual sets of information with regard to the participation topic “total eclipse of the moon” is less than or equal to a preset number, that is, when the number of sets of information is insufficient, the search service system may recommend an input of additional information to users. As another example, when a participation topic with regard to a recent incident is not generated, the search service system may recommend generation of the participation topic using a keyword associated with the incident to the users. As another example, the search service system may recommend, to the users, generating a participation topic for an expanded keyword “total eclipse of the moon proof shot” of the participation topic “total eclipse of the moon” or may recommend generating a participation topic associated with “Kwanghwamoon” to a user located at “Kwanghwamoon.”

Further, a user having initially input the participation topic that is generated based on the topic input through the search site may become an owner for the participation topic or the owner may be replaced based on a user reaction to the participation topic. That is, the user having initially generated the participation topic with regard to the “total eclipse of the moon” may become the owner. Additional information with regard to the “total eclipse of the moon” may be received from a plurality of users and the owner may be replaced based a user reaction accordingly. For example, a user of a post having received a largest number of “likes” among posts of the participation topic with regard to the “total eclipse of the moon” may become the owner.

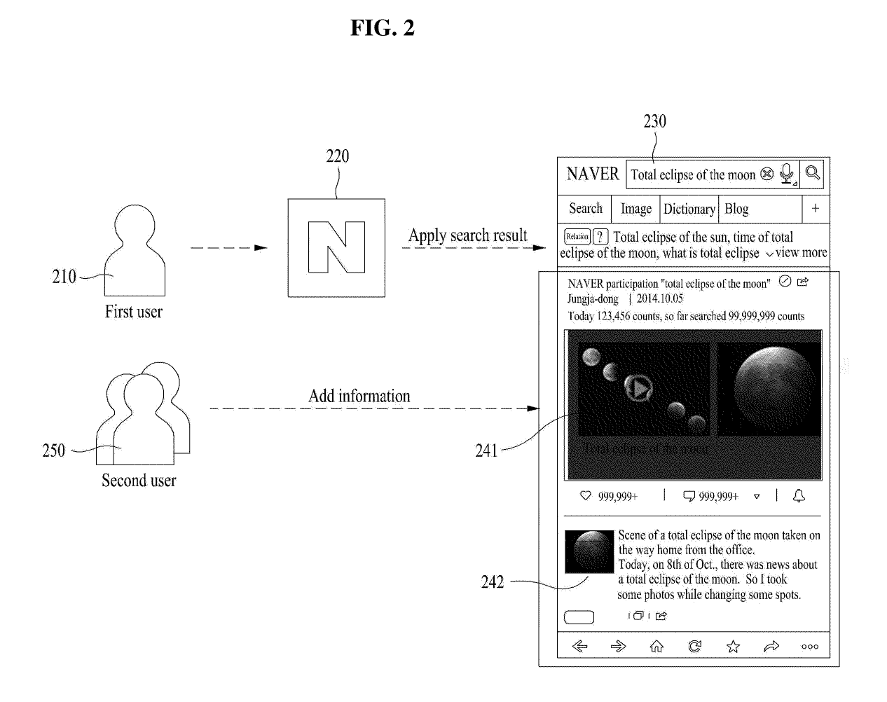

FIG. 2 illustrates an example of an entire process in which a user generates a participation topic according to one or more example embodiments.

A first user 210 may transmit a request for generating a participation topic to a search service system 220. For example, when the first user 210 is to generate a participation topic with regard to a specific topic “total eclipse of the moon” 230, the first user 210 may transmit a request for generating the participation topic to the search service system 220 by inputting the topic “total eclipse of the moon” 230 at a search site provided in the search service system 220.

The search service system 220 may verify whether or not a previously generated participation topic is present with respect to the topic requested from the first user 210. When the previously generated participation topic is absent, the search service system 220 may allow a new participation topic to be generated and may apply the new participation topic to a search result. For example, the first user 210 may upload information including a photo, a video, a text, etc., associated with the new participation topic through the search site. The search service system 220 may store and manage the uploaded information in association with the participation topic.

In an example in which the participation topic for the “total eclipse of the moon” 230 is generated and a second user 250 may conduct a search using the keyword “total eclipse of the moon” 230 at the search site, information stored in association with the participation topic may be displayed together with a search result with regard to the keyword “total eclipse of the moon” 230. FIG. 2 illustrates an example in which information 241 including videos, photos, etc., are displayed as user participation information at the search site. Here, the search result may also include a general search result 242 with regard to the keyword “total eclipse of the moon” 230.

Here, other users, for example, the second users 250 may exchange information between users and expand the range of information by further adding information with regard to the participation topic. For example, the second user 250 interested in the same topic as the first user 210 may parse a variety of information by inputting additional information with regard to the same participation topic. For example, the search site may include a user interface (not shown) of inputting additional information in association with the displayed user participation information. The second user 250 may upload additional information through the user interface, and the search service system 220 may expand user participation information by further storing and managing the uploaded additional information in association with the participation topic.

In the same manner, the second user 250 may add a video, a photo, and relevant information with regard to the participation topic and may post an opinion with regard to the participation topic and the information may be shared between users. In the event that the second user 250 does not upload information, the user participation information may be displayed to users having input keywords associated with the participation topic and a search result may be provided.

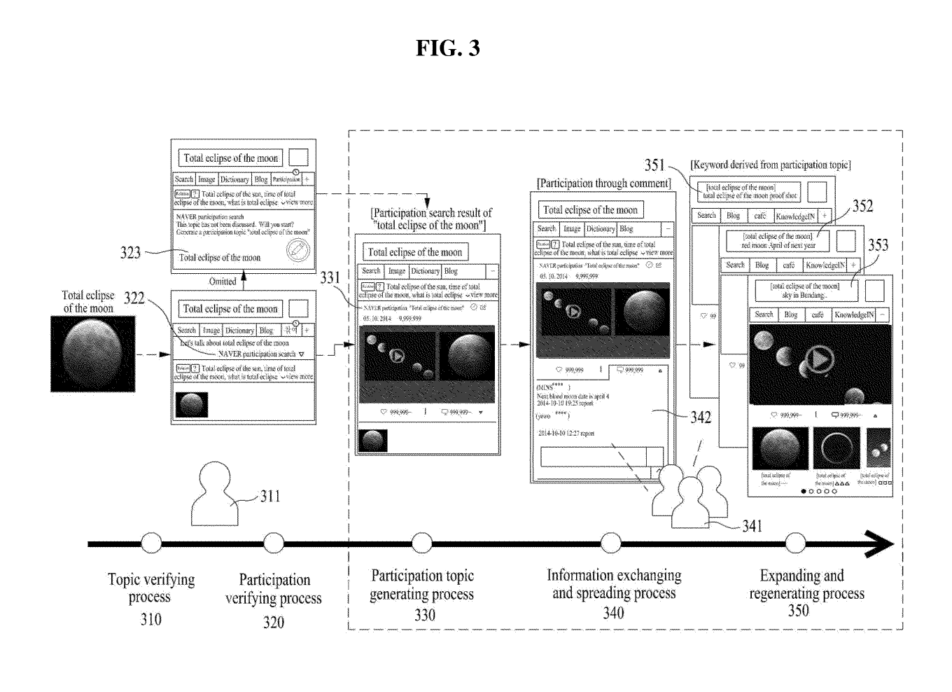

FIG. 3 illustrates an example of a process in which a user generates a participation topic and generates a communication space according to one or more example embodiments.

A user 311 who is to generate a participation topic may transmit a request for generating a participation topic to a search service system.

In a topic verifying process 310, the search service system may verify whether or not the participation topic for an input keyword is present.

In a participation verifying process 320, the search service system may verify whether or not the user is to participate in the participation topic for the input keyword. For example, a first area 322 includes content indicating that a participation topic for an input keyword “total eclipse of the moon” is already present and asking the user whether to participate in the participation topic and a second area 323 includes content indicating that the participation topic for the input keyword “total eclipse of the moon” is absent and asking the user whether to generate the participation topic.

In a participation topic generating process 330, the search service system may generate the participation topic “total eclipse of the moon” based on a selection of the user. A third area 331 indicates an area on which user participation information with regard to the participation topic “total eclipse of the moon” is displayed.

In an information exchanging and spreading process 340, when the participation topic “total eclipse of the moon” is already generated, the search service system may spread the user participation information through additional information input from the user. A fourth area 342 shows an example in which opinions with regard to the user participation information are added as additional information input through other users 341.

In an expanding and regenerating process 350, in response to users inputting additional information, information with regard to the participation topic “total eclipse of the moon” may be expanded. Through individual information, new keywords, for examples, “[total eclipse of the moon] total eclipse of the moon proof shot” 351, “[total eclipse of the moon] red moon April of next year” 352, “[total eclipse of the moon] sky in Bundang . . . ]” 353, etc., may be derived.

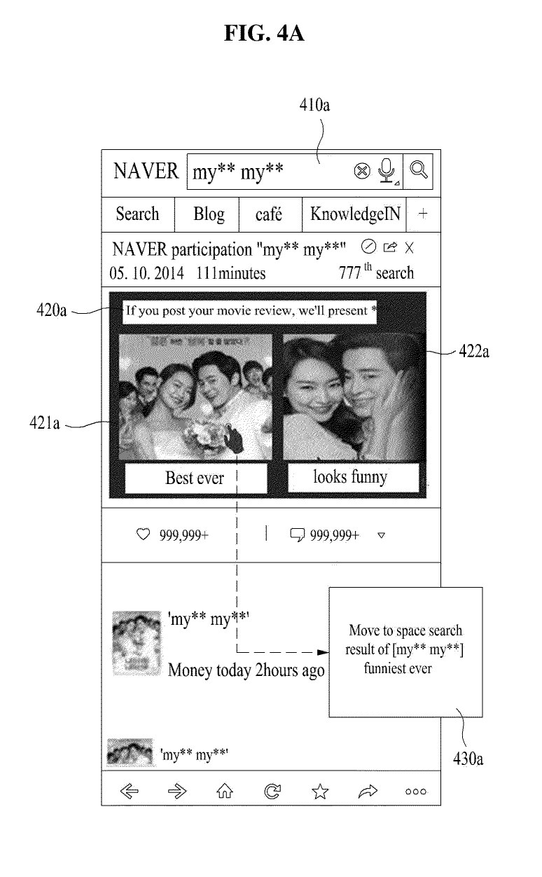

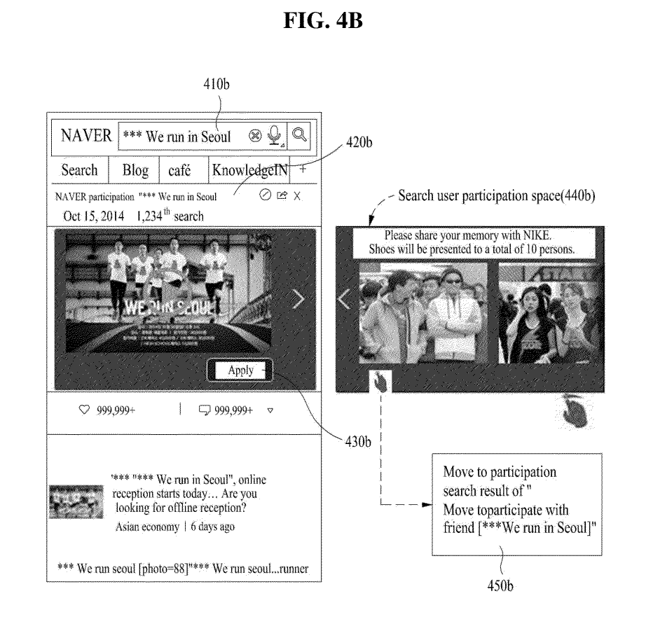

FIGS. 4A and 4B illustrate examples of an event area using method for inducing user participation with regard to a participation topic according to one or more example embodiments.

FIG. 4A illustrates an example of inducing participation of users by registering a participation topic for a movie on screen. When a first user inputs a keyword “my** my**” 410a that is a movie title, user participation information stored with regard to a participation topic may be displayed through a search site. Here, the user participation information may be information uploaded by a person concerned in the movie. FIG. 4A illustrates an example of displaying information 420a indicating that a reward can be provided for uploading a movie review. Further to the first user (e.g., a person concerned in the movie), a plurality of users may participate in a search result by uploading, for example, information 421a by a second user, information 422a by a third user.

Here, information uploaded by each of the users may be present as an individual document. For example, the information of FIG. 4A may be representative information of the respective individual documents and may include links to the individual documents. If the first user clicks on the information 421a uploaded by the second user, for examples, the first user taps a corresponding area of a touch screen in a wireless environment, the first user may be moved to an individual document uploaded by the second user as a space search result of “[my** my**] funniest ever” as illustrated in 430a, and be provided with the document.

FIG. 4B illustrates an example of inducing interest of users by generating a participation topic for an event of a specific company. If a user inputs a keyword associated with a specific company, for example, a keyword “*** We run in Seoul” 410b, user participation information 420b with regard to a participation topic “*** We run in Seoul” may be displayed through a search site. The user participation information 420b may include a user interface 430b in which a link to a document for participating in a corresponding event is set. In addition to the user participation information 420b of the company hosting the event, user participation information 440b of general search users may be displayed through the search site. For example, if the user swipes the corresponding area or taps the user interface for navigating information in a state in which the user participation information 420b is displayed, the user participation information 420b displayed on the area may be replaced with another item of user participation information 450b.

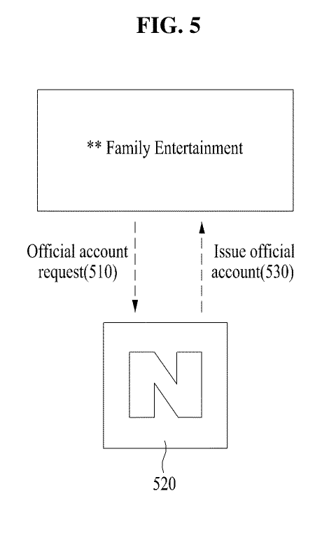

FIG. 5 illustrates examples of a method of using a mutual communication space using official accounts of users according to one or more example embodiments.

FIG. 5 illustrates a process in which a specific company transfers an official account request 510 to a search service system 520 through, for example, a system of the specific company and the search service system 520 issues an official account 530 in response to the official account request 510. For example, a specific entertainment company may request the search service system 520 to generate a participation topic for a name of the company as an official account.

According to one example described herein, there is an example in which a participation topic for an official account “** family”. In response to a user inputting a keyword “** family” at the search site, user participation information stored in association with the participation topic is displayed. Here, album promotion information of a musician of an entertainment company is further displayed as the user participation information. Even in this case, information uploaded by general search users may be further displayed as the user participation information. A reference numeral indicates that a specific user may move to a document of specific information by selecting, for example, clicking on or tapping, the specific information.

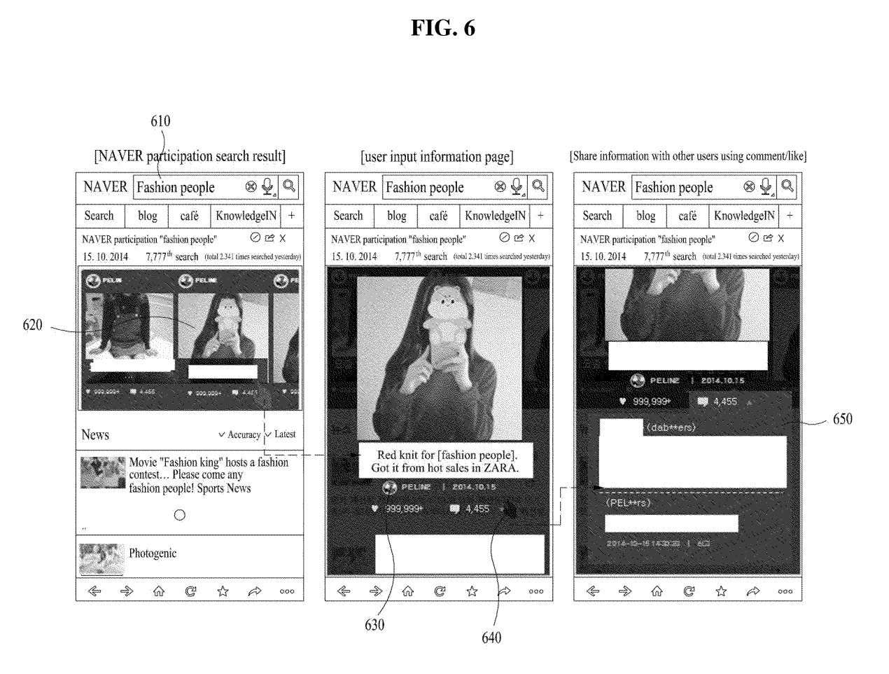

FIG. 6 illustrates an example of a method of sharing information between users having a common interest according to one or more example embodiments. FIG. 6 illustrates an example of displaying user participation information 620 with regard to a participation topic “fashion people” through a search site in response to an input of a keyword “fashion people” 610. Here, in response to a user selecting specification information, a document including the specific information may be provided. As illustrated in FIG. 6, the selected information may be expanded and thereby displayed on a current page. Information displayed through expansion may include information 630 with regard to a user having uploaded the selected information or a user interface 640 enabling expansive display of information that is additionally uploaded in association with the selected information. When the user interface 640 is selected by the user, comments 650 on the selected information may be additionally displayed through expansion. Using the user participation information 620 or the comments 650, search users having a common matter of interest may directly fill out information with regard to a search result. That is, the search service system may service an online participation space in which the users fill out information.

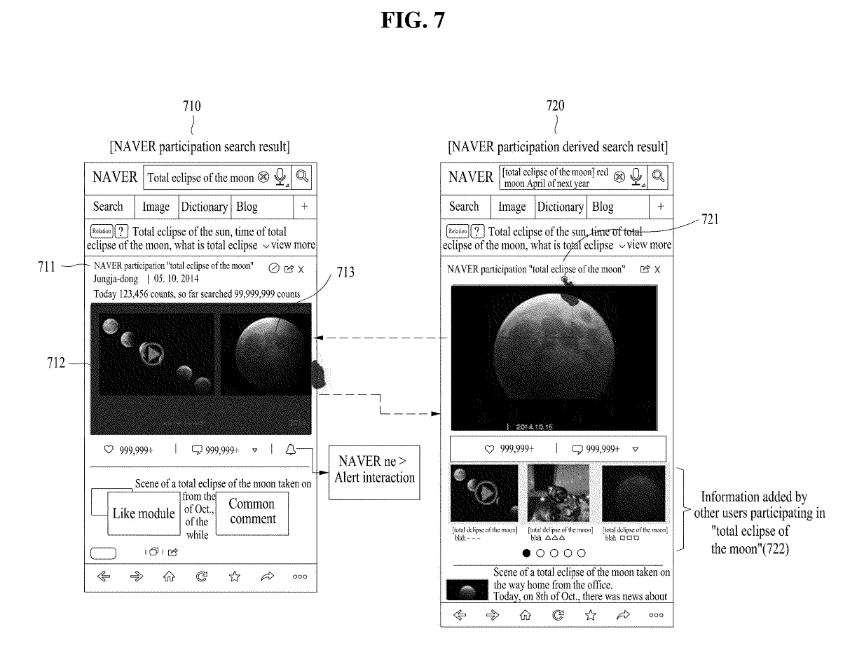

FIG. 7 illustrates an example of a participation search result and a participation derived search result according to one or more example embodiments.

Information uploaded by users may be a search result derived from a participation topic. For example, on a first search page 710, user participation information 712 with regard to a participation topic “total eclipse of the moon” 711 is displayed as a search result of a keyword “total eclipse of the moon”. Here, individual information uploaded by users refers to a search result derived from the participation topic “total eclipse of the moon” 711. In response to a user selecting a derived search result 713, the first search page 710 may be replaced with a second search page 720 and the derived search result 713 may be displayed through expansion. Here, other derived search results 722 may be displayed. In response to the user selecting a link 721 set to the participation topic “total eclipse of the moon”, the second search page 720 may be replaced with the first search page 710 and the first search page 710 may be displayed again.

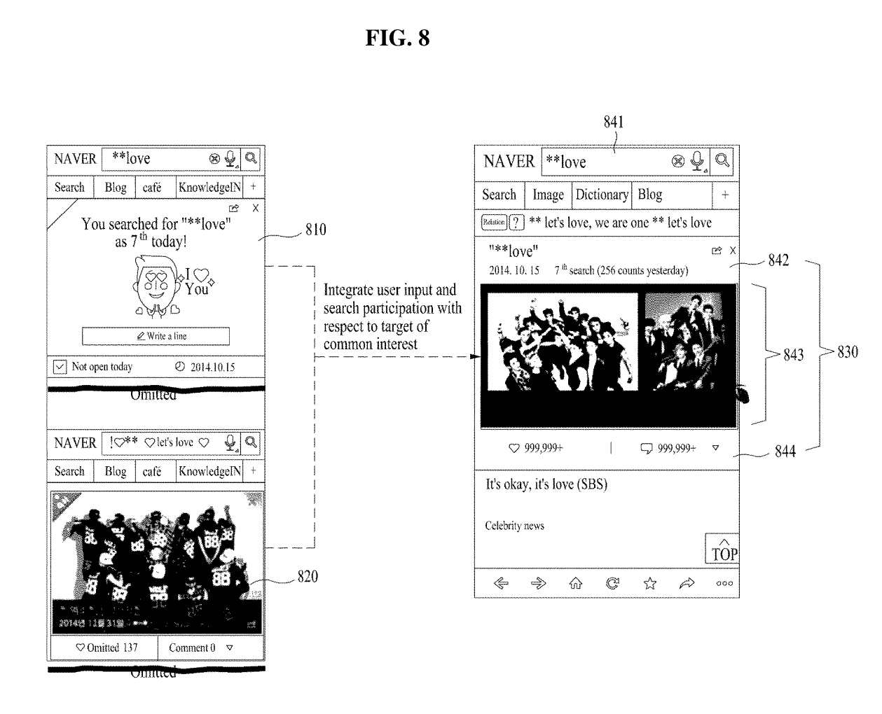

FIG. 8 illustrates an example of evaluating users based on a user participation level according to one or more example embodiments. Referring to FIG. 8, an area 810 of a first search page shows an example of inducing interest of a user by displaying information about search order of the user in response to the user conducting a search with regard to a participation topic “**love”. Further, an area 820 of a second search page shows an example of a user interface that enables users to participate in a target of interest, for example, through comments or expression of interest. A third search page 830 shows an example in which a function of the first search page and a function of the second search page are combined. For example, the third search page 830 shows an example in which information with regard to search order of the user is displayed on user participation information 842 with regard to the participation topic “**love” in response to an input of a keyword “**love” 841. Further, the third search page 830 includes information 843 uploaded by search users and a user interface 844 for participating in a target of interest through an expression of interest or a comment.

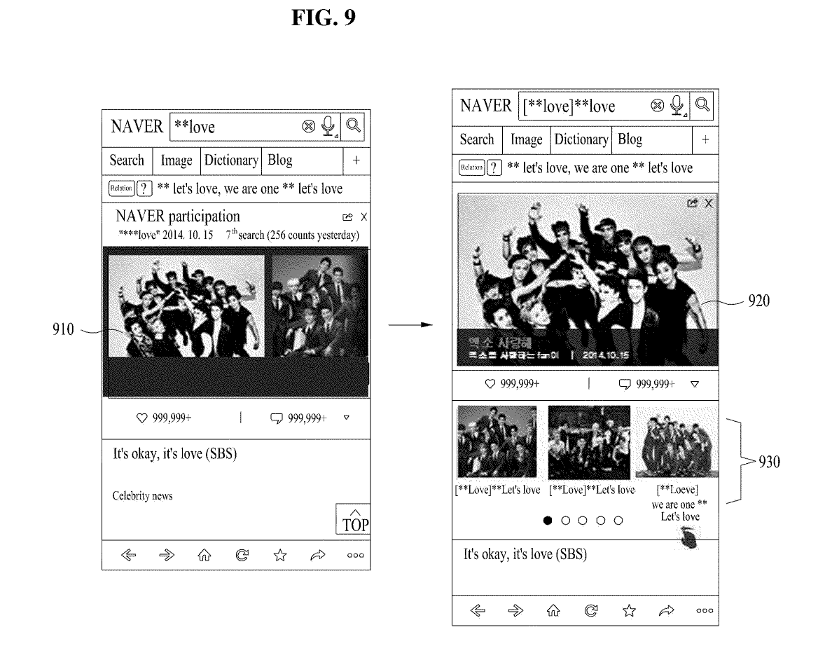

FIG. 9 illustrates an example of a page of information with regard to a participation topic according to one or more example embodiments. Referring to FIG. 9, a first search page shows an example in which a plurality of user participation information is displayed. In this example, when a user selects specific information 910, information 920 expanded from the specific information 910 may be displayed through a second search page and information 930 uploaded by other users may be separately displayed.

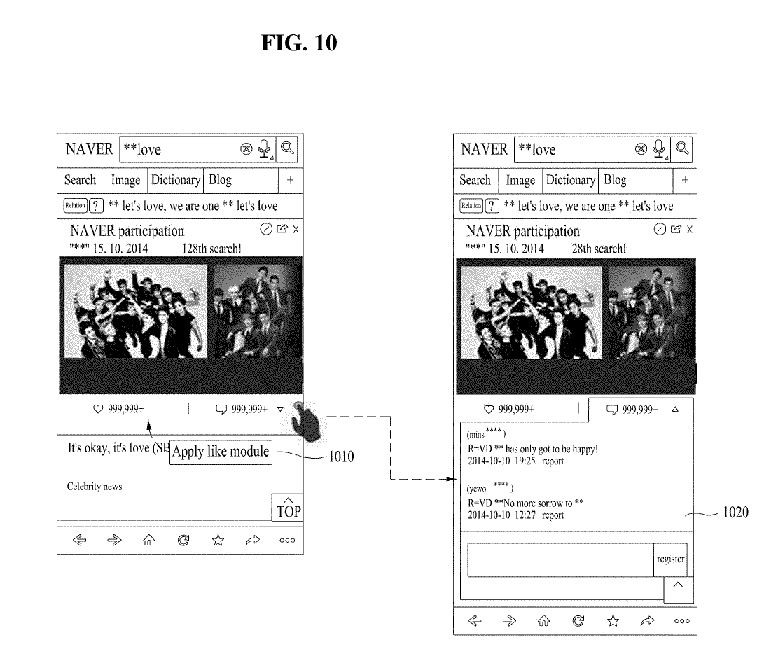

FIG. 10 illustrates an example of a participation comment according to one or more example embodiments. Referring to FIG. 10, a user interface 1010 that enables other users to express their interest may be set to user participation information with regard to a participation topic. The users may share information through comments 1020 on the user participation information.

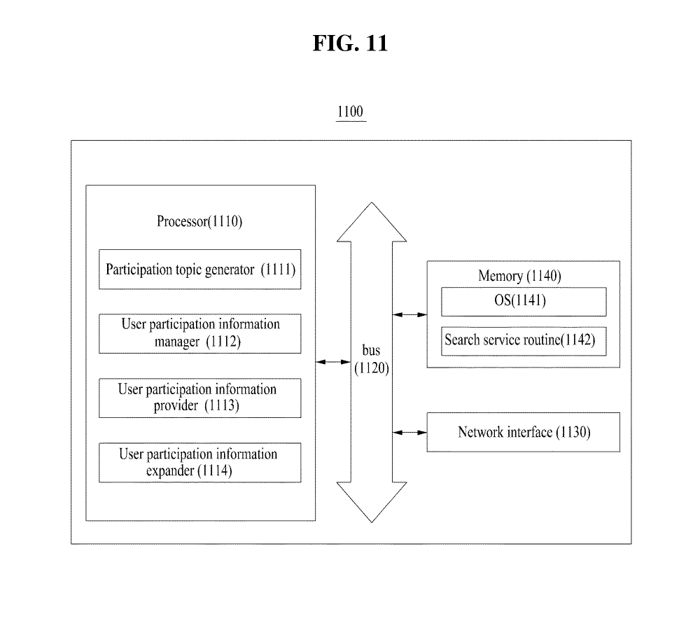

FIG. 11 is a block diagram illustrating a configuration of a search service system using a user participation in an information search result according to one or more example embodiments.

A search service system 1100 of FIG. 11 may correspond to the aforementioned search service system. Referring to FIG. 11, the search service system 1100 may include one or more computing devices, such as a server, that include a processor 1110, a bus 1120, a network interface 1130, and a memory 1140. The memory 1140 may include an operating system (OS) 1141 and a search service routine 1142. The processor 1110 may include a participation topic generator 1111, a user participation information manager 1112, a user participation information provider 1113, and a user participation information expander 1114. According to other example embodiments, the search service system 1100 may include a greater or lesser number of constituent elements than the number of constituent elements shown in FIG. 11. For example, the search service system 1100 may include other constituent elements such as a display, a transceiver, etc.

The memory 1140 may include a permanent mass storage device, such as random access memory (RAM), read only memory (ROM), a disc drive, a solid state drive, an optical drive, etc., as a computer-readable storage medium. Also, program codes (e.g., computer readable instructions) for the OS 1141, the search service routine 1142, and the computer readable instructions may be stored in the memory 1140. Such software constituent elements may be loaded from another computer-readable storage medium separate from the memory 1140 using a drive mechanism (not shown). The other computer-readable storage medium may include, for example, a floppy drive, a disc, a tape, a DVD/CD-ROM drive, a memory card, etc. Software constituent elements may be loaded to the memory 1140 through the network interface 1130 instead of, or in addition to, the computer-readable storage medium. For example, the search service routine 1142 may be loaded to the memory 1140 based on a program installed by files provided from developers over a network.

The bus 1120 enables communication and data transmission between the constituent elements of the search service system 1100. The bus 1120 may be configured using a high-speed serial bus, a parallel bus, a storage area network (SAN), and/or another appropriate communication technology.

The network interface 1130 may be a computer hardware constituent element for connecting the search service system 1100 to the computer network. The network interface 1130 may connect the search service system 1100 to the computer network through a wireless and/or wired connection.

The processor 1110 may be configured to process computer-readable instructions of a computer program by performing a basic arithmetic operation, a logic operation, and an input/output operation of the search service system 1100. The computer-readable instructions may be provided from the memory 1140 and/or the network interface 1130 to the processor 1110 through the bus 1120. The processor 1110 may be configured to execute program codes for the participation topic generator 1111, the user participation information manager 1112, the user participation information provider 1113, the user participation information expander 1114, etc. The program codes may be stored in a storage device such as the memory 1140, for example, the search service routine 1142.

Here, the participation topic generator 1111, the user participation information manager 1112, the user participation information provider 1113, and the user participation information expander 1114 may be configured to perform operations 110 through 140 of FIG. 1. Although not shown, the processor 1110 may further include an evaluation point assigner, a recommender, etc., to process non-illustrated operations according to other example embodiments.

As described above, according to one or more example embodiments, a search user may participate in an information search result by generating a participation topic in which the search user is interested and by expanding information with regard to the participation topic together with other search users. Further, the expanded information may be provided as a search result through the participation of the users in the search result and may be shared between the users.

According to one or more example embodiments, a retargeting search service system may analyze a utilization time of a user mobile terminal and a user computer terminal and may provide retargeting keywords to the user mobile terminal or the user computer terminal on a preset time based on a stored log.

According to one or more example embodiments, a retargeting search service providing system enables interaction between data retrieved from a user mobile terminal and data retrieved from a user computer terminal based on log-in information and unidentifiable personal information.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims.

What is claimed is:

1. A search service method using a user participation in an information search result, the method comprising:
generating a participation topic based on a topic input through a search site;
receiving, through the search site, information associated with the participation topic from a user, and storing and managing the received information in association with the participation topic;
providing the information stored in association with the participation topic as user participation information through the search site, in response to an input of a keyword, which is associated with the participation topic and input through the search site; and
expanding the user participation information based on an input of additional information in association with the provided information through the search site.

2. The method of claim 1, wherein the generating a participation topic comprises verifying whether or not a previously generated participation topic with regard to the topic input from the user is present, and generating a new participation topic based on the input topic when the previously generated participation topic is absent.

3. The method of claim 2, wherein the providing the information comprises providing a user with information stored in association with the previously generated participation topic, when the previously generated participation topic is present.

4. The method of claim 1, wherein the user participation information comprises at least one of a video, a photo, and a user opinion, and
the search service method further comprises sharing the user participation information between users having input keywords associated with the participation topic through the additional information.

5. The method of claim 1, further comprising:
generating a participation space for users using at least a portion of the search site, and
providing, in the generated participation space, a user interface capable of inputting the additional information with regard to the user participation information and the participation topic.

6. The method of claim 1, wherein the generating a participation topic comprises:
issuing an official account for a company or an organization in response to a request from the company or the organization; and
generating a participation topic for the official account.

7. The method of claim 1, wherein the generating a participation topic comprises generating the participation topic for an event or a festival associated with the user in response to a request from the user.

8. The method of claim 1, further comprising:
assigning evaluation points for each item of information included in the user participation information, based on at least one of a user participation level, a presence of self-production of information, and a presence of a link.

9. The method of claim 8, further comprising:
assigning, based on the evaluation points, a master position for the participation topic to a user that is selected from among users having provided information included in the user participation information.

10. The method of claim 1, wherein the providing the information comprises:
classifying individual information included in the user participation information based on a topic or a content type; and
displaying the classified information for each classification item through the search site.

11. The method of claim 1, further comprising:
recommending, to the user, generation of the participation topic for a preset keyword or input of the additional information to the user.

12. The method of claim 11, wherein the preset keyword comprises at least one of a keyword that is extracted based on at least one of a number of individual items of information included in the user participation information, a time at which an incident associated with the participation topic has occurred, an expanded keyword for the participation topic, and a keyword that is extracted in association with a location of at least one user.

13. The method of claim 1, wherein a user having initially input the participation topic that is generated based on the topic input through the search site becomes an owner for the participation topic or the owner is replaced based on a user reaction to the participation topic.

14. A search service system for providing a search service using a user participation in an information search result, comprising:
one or more processors configured to execute computer-readable instructions to,
generate a participation topic based on a topic input through a search site,
receive, through the search site, information associated with the participation topic from a user, and store and manage the received information in association with the participation topic,
provide the information stored in association with the participation topic as user participation information through the search site, in response to an input of a keyword, which is associated with the participation topic and input through the search site, and
expand the user participation information based on an input of additional information in association with the provided information through the search site.

15. The search service system of claim 14, wherein the processor is further configured to verify whether or not a previously generated participation topic with regard to the topic input from the user is present, and generate a new participation topic when the previously generated participation topic is absent.

16. The search service system of claim 14, wherein the user participation information comprises at least one of a video, a photo, and a user opinion, and
the processor is further configured to share the user participation information between users having input keywords associated with the participation topic through the additional information

17. The search service system of claim 14, wherein the processor is further configured to generate a participation space for users using at least a portion of the search site, and provide, in the generated participation space, a user interface capable of inputting the additional information with regard to the user participation information and the participation topic.

18. The search service system of claim 14, wherein the processor is further configured to issue an official account for a company or an organization in response to a request from the company or the organization, and generate a participation topic for the official account.

19. The search service system of claim 14, wherein the processor is further configured to generate the participation topic for an event or a festival associated with the user in response to a request from the user.

20. The search service system of claim 14, the processor is further configured to assign evaluation points for each item of information included in the user participation information, based on at least one of a user participation level, a presence of self-production of information, and a presence of a link.

21. The search service system of claim 14, wherein the processor is further configured to recommend generation of the participation topic for a preset keyword or input of the additional information to the user,
wherein the preset keyword comprises at least one of a keyword that is extracted based on at least one of a number of individual items of information included in the user participation information, a time at which an incident associated with the participation topic has occurred, an expanded keyword for the participation topic, and a keyword that is extracted in association with a location of at least one user.
